(19) United States
(12) Patent Application Publication
(10) Pub. No.: US 2025/0020089 A1
(43) Pub. Date: Jan. 16, 2025

(54) DIESEL ENGINE WITH HIGH-PRESSURE INJECTION AND CHARGING FUNCTION, AND PISTON OR A DIESEL ENGINE

(71) Applicant: NEWGREEN AG, Staad (CH)

(72) Inventor: Stephan Geschke, Staad (CH)

(21) Appl. No.: 18/710,435

(22) PCT Filed: Dec. 22, 2022
(86) PCT No.: PCT/EP2022/087654

§ 371 Date: May 15, 2024

(30) Foreign Application Priority Data
Dec. 23, 2021 (DE) 10 2021 134 521.9

(51) Int. Cl. F02F 3/22; F01M 1/06; F02F 3/02

(52) U.S. Cl. CPC F02F 3/22; F01M 1/06; F02F 3/02; F01M 2001/062

(57) ABSTRACT

The invention relates to a diesel engine with high-pressure injection and supercharging (Question to inventor: which components define a “diesel engine” with the corresponding properties and/or a compression temperature of more than 700° C. and/or a combustion temperature of more than 1200° C., a cylinder or several cylinders with a respective cylinder bore, a connecting rod associated with a respective cylinder and a piston arranged in the respective cylinder bore with a top side, an under side and a circumferential surface with a temperature of more than 700° C. and/or a combustion temperature of more than 1200° C., an under side and a circumferential surface with a nominal diameter, the upper side being designed to absorb pressure forces of a gas inside the respective cylinder, the underside having a connecting rod holder with an undercut acting in a tensile and a pressure direction, so that the connecting rod holder is designed to positively receive a head region of the respective connecting rod which corresponds to the receptacle and is pivotable about a pivot axis, and the circumferential surface is designed to guide the piston in the respective cylinder bore along an axis of movement and with a ring groove for a piston ring for sealing the piston with respect to the respective cylinder bore and has a circumferential collar extending from the upper side with a height arranged between the upper side and the ring groove for the piston ring. Furthermore, the invention relates to a corresponding piston of a diesel engine.

### CROSS-REFERENCES TO RELATED APPLICATIONS

This is a U.S. national stage filing based on PCT/EP2022/087654

### STATEMENT REGARDING FEDERALLY SPONSORED RESEARCH OR DEVELOPMENT

Not applicable

### Microfiche Appendix

Not applicable

### BACKGROUND OF THE INVENTION

The invention relates to a diesel engine with high-pressure fuel injection and turbocharging and/or a compression temperature of more than 700° C. and/or a combustion temperature of more than 1,200° C. The invention encompasses one or more cylinders with a respective cylinder bore, a piston assigned to a respective cylinder and a connecting rod attached to the piston. The inventive piston has a top side, an under side and a circumferential surface. The top side is designed to absorb the compressive forces of a gas within the respective cylinder. The piston's under side includes a connecting rod holder with an undercut acting to retain a connecting rod head so that the connecting rod holder positively and pivotally receives the thickened head region of the respective connecting rod. The piston's circumferential surface guides the piston along a movement axis in the respective cylinder bore. The piston includes a ring groove for a piston ring for sealing the piston with respect to the respective cylinder bore. The piston also includes a perimeter collar proximate the top side extending upward from the ring groove. The present inventive piston is particularly adapted to a diesel engine.

Combustion engines based on the diesel principle have undergone extensive development. Modern diesel engines are now powered by means of high-pressure fuel injection combined with turbocharging and/or supercharging. These developments mean that correspondingly high compression and combustion temperatures are achieved, and the fuel efficiency of the respective diesel engine is greatly increased. However, this also produces significant heat management challenges, particularly with respect to the pistons. The pistons in modern diesel engines in particular must be shaped to accommodate significant thermal expansion. In particular, such pistons are made in an oval shape and designed to achieve a cylindrical shape when they are heated to the range of normal operating temperature. Such pistons also often have a pronounced so-called firewall, i.e. a region of the circumferential surface above the top compression ring proximate the combustion chamber. This feature is particularly important for pistons that are pivotally joined to a connecting rod head using a separate piston pin (a “wrist pin”).

The object of the invention is to improve the state of the art.

### BRIEF SUMMARY OF THE PRESENT INVENTION

The problem is solved by a diesel engine with high-pressure injection and turbocharging and/or supercharging, having a compression temperature of more than 700° C. and/or a combustion temperature of more than 1, 200° C. The inventive engine has one or more cylinders each having a respective cylinder bore, a piston assigned to each respective cylinder bore and a connecting rod pivotally connected to the piston. Each piston has a top side, an under side, and a circumferential surface with a nominal diameter, the top side being designed to absorb compressive forces of a gas within the respective cylinder, the underside having a connecting rod holder configured to pivotally engage and retain a thickened head region of a connecting rod. The connecting rod holder has an undercut positioned to retain the head region and resist the head region pulling free of the connecting rod holder in a form-fitting manner and pivotable about a pivot axis with respect to the piston. The piston's circumferential surface is set up to guide the piston in the respective cylinder bore along an axis of movement. The circumferential surface includes a ring groove for a piston ring for sealing the piston with respect to the respective cylinder bore. The piston has a perimeter collar (circumferential collar) extending from the ring groove toward the top of the piston. The piston is designed so that a diameter of the circumferential collar is more than 98% of the nominal diameter of the circumferential surface. The piston is particularly suited for use in a diesel engine.

A diesel engine of this type has a piston having a perimeter collar (circumferential collar) of almost the same diameter as the diameter of the circumferential surface, since in the embodiment described there is no longer any need for an embossed firewall to accommodate shape variation caused by thermal expansion.

The following terms are explained in this context:

A “diesel engine” is an internal combustion engine, in particular, a reciprocating piston internal combustion engine, which initiates the power stroke by compression ignition. In this process, injected fuel, for example a diesel fuel, is injected into a combustion chamber. At the time of injection, the temperature of the gas within the combustion chamber is already greatly increased by the compression stroke of a piston. This results in spontaneous combustion of the usually finely atomized fuel within the cylinder—as it is injected. In this context, the term Diesel engine includes an engine which operates according to mixed principles of Otto cycle and Diesel cycle engines. The term refers to a four-cycle engine which uses primarily compression ignition. A diesel engine of this type has a “high-pressure injection” system, for example by means of a common rail or another arrangement. Fuel is injected into the combustion chamber at a usually very high injection pressure of over 1,000 bar, for example. Such a diesel engine can also be “supercharged” by means of a mechanical compressor (supercharger) or a turbocharger, which raises the induction air pressure, so that a higher mass of air and thus a higher power output can be achieved.

In this context, a “compression temperature” is the temperature inside the cylinder that is reached when a piston of the crank mechanism of such a diesel engine compresses air that has been sucked in and is used for the compression stroke. Usually such a compression stroke is carried out directly before the combustion cycle. In contrast, a “combustion temperature” is the temperature that develops during the subsequent injection of fuel and the resulting combustion (the power stroke).

A “cylinder bore” can be, for example, a cast and/or machined bore within an engine block of an internal combustion engine, which is then further refined, for example by honing, to create a “cylinder.” However, such a cylinder bore can also be a round or essentially round unsealed cavity of a steam engine, an expansion drive, or another form of power engine. The piston closes the open side of the cylinder bore, so that compressive force within the cylinder bore then exerts force on the piston.

A “connecting rod” is used in a so-called “crank unit” to transfer the reciprocating motion of a piston to the rotational motion of an attached crankshaft. The head region of the connecting rod is pivotally connected to the piston whereas a foot area of the connecting rod is connected to the crankshaft. A middle region connects the head region to the foot area. The foot area is rotationally connected to an eccentric crankpin of the crankshaft.

A “piston” is a movable component which, together with a surrounding housing, in the case of an engine and related machines comprises a “cylinder.” The volume of the cylinder changes due to a reciprocating movement of the piston in the cylinder. Such a principal can be realized in different ways in different designs, in the case of the present invention, in particular a reciprocating piston that can be moved up and down within a cylinder.

An “upper side” (top side) of such a piston is, for example, the area of the piston known as the piston crown, which in an internal combustion engine, for example, is assigned to the combustion chamber volume. This upper side then, using the example of the internal combustion engine, absorbs the pressure forces from the expanding ignited gas mixture and thus transfers the forces required to operate the crankshaft drive to the connecting rod and from thence to the crankshaft.

An “under side” is the side of the piston facing the connecting rod, i.e. in particular the side of the piston that has the connecting rod holder.

A “circumferential surface” is the surface of the piston which, for example, faces the cylinder bore in the case of an internal combustion engine. The exemplary details given refer to the usual design of a piston having a generally cylindrical shape. Likewise, a correspondingly different shape of piston and a different shape of cylinder bore can also be realized if technically feasible. The circumferential surface can also typically be used as a so-called piston skirt.

This circumferential surface has a so-called “nominal diameter”, which denotes, for example, the intended diameter of the circumferential surface of the piston.

A “gas” that exerts compressive forces can be a simple compressed gas, such as compressed air, or a gas resulting from a phase transition, such as superheated steam, or even a gas mixture of for example, ambient air and gasoline or diesel or another fuel which exerts pressure forces through ignition and combustion, for example in a gasoline or diesel engine.

A “connecting rod holder” on the underside of the piston is used to attach a connecting rod to the piston in a tension-proof and pivotable manner, so that the piston together with the connecting rod are linked together in a so-called crank drive, for example in a connecting rod linking a piston to a crankshaft. A pivoting connection of the piston to the connecting rod is established in such a way that the piston is free to pivot with respect to the connecting rod, but it otherwise secured thereto.

An “undercut” refers to such a design of a mount or part of a mount in which a component or an area or partial area in the direction of force positively prevents a pull-out or positively enables a transmission of forces. Such an undercut can be used by a component suspended or attached via the undercut to transmit forces.

A “swivel axis” is, for example, the axis around which the connecting rod is rotatably or pivotably attached to the piston. This swivel axis corresponds, for example, to the axis of the piston pin in the prior art.

A “thickening” (such as a head) of the connecting rod is such an area which has a larger or wider cross-section or has a larger or wider diameter than a part of the connecting rod located adjacent to the thickening. In particular, such a thickening can serve, together with the undercut, in particular with the surfaces formed by the undercut, to create a form-fit tensile or torsional connection to form a force-resistant connection.

An “axis of movement” describes an axis along which the piston moves during a rotation of the crankshaft. In particular, this axis of movement is substantially parallel to a center axis of a cylinder bore of the cylinder. The axis is not an exact axis, but a corresponding direction with technical deviations.

A “piston ring” is a ring that is usually installed into a circumferential annular ring groove of the respective piston, which acts as a sealing element between the piston and cylinder bore. Such a piston ring is designed with different functions; in relation to the invention, the top compression ring usually arranged in the uppermost position in the direction of the upper side is in direct contact with the combustion chamber.

This piston ring serves to “seal” the gap between the perimeter of the piston and the cylinder bore, i.e. to prevent combustion gases in particular from escaping past the piston into the lower portion of the cylinder bore and the crankcase.

A “circumferential collar” is a part of the circumferential surface of the piston proximate the upper ring groove and the top side (crown). A circumferential collar is usually also known as a “firewall”. The “diameter” of the circumferential collar is determined, for example, from a mean radius of the circumferential collar, i.e. a diameter calculated using statistical methods using the radii of all points of the circumferential collar in relation to the for example to the axis of movement. Significant to the invention is the fact that this circumferential collar, i.e. the fire bar, in the best case does not have a radius difference compared to the circumferential surface of the rest of the piston. This allows the circumferential surface to be manufactured in one pass and one clamping operation.

In order to further simplify the production of the diesel engine, in particular a piston for this diesel engine, the diameter of the circumferential collar is preferably more than 99%, more preferably more than 99.5%, and in particular more than 99.8% of the nominal diameter of the circumferential surface.

In one embodiment, the diameter of the circumferential collar is equal to the nominal diameter of the circumferential surface.

In this context, “equal” does not only mean a pure mathematical equality, but also a technically conditioned equality, whereby, for example, when clamping the piston in a lathe for the defined removal of material to produce the circumferential surface, the same setting of a tool with regard to the radius is used in order to turn the circumferential surface and the circumferential collar. This significantly simplifies the production of the corresponding diesel engine or piston.

In order to make the diesel engine more powerful and to further improve thermal management on the piston, the height of the circumferential collar along the axis of movement is preferably less than 5%, more preferably less than 3%, even more preferably less than 2%, and in particular less than 1% of the overall height of the piston.

This makes the piston itself significantly flatter and moves the top side closer to the upper ring groove so that, in conjunction with the design of the connecting rod with a head region configured to connect to a connecting rod receiver in the piston, the top piston ring groove can be moved closer to the top side (piston crown). Good heat dissipation of the piston is achieved without the requirement of a pronounced circumferential collar. This has the particular advantage, also in combination with the other details mentioned above, that no or only little combustion residue is deposited on the firewall so that, particularly in the case of alternating operation of the diesel engine between, for example, city traffic and long-distance travel, less damage to the diesel engine is caused by deposits carried out, mechanical rubbing in the cylinder bore or similar effects.

The “height” of the piston and a related “height of the circumferential collar” are dimensions that are parallel to the piston's axis of movement. The height of the circumferential collar is generally defined as the distance from the upper circumferential edge of the piston around the upper side to the uppermost ring groove. The overall height of the piston describes the height between the top side and the underside, whereas other parts of the piston, such as a piston skirt, for example, can be measured from the bottom of the lowest ring groove to the lowest extreme of the piston under side.

Such a “piston skirt”, which denotes a tube-like extension of the piston in the direction of the underside, i.e. in the direction of the crankshaft, is particularly thin, so that a weight advantage is achieved. Thermal expansion is at best greatly reduced.

In one embodiment, a radius of the circumferential surface, a radius of the circumferential collar, a radius of a nominal contour of the circumferential surface and/or a radius of the nominal contour of the circumferential collar has a deviation from a mean radius of the circumferential surface, a mean radius of the circumferential collar, a mean radius of the nominal contour of the circumferential surface and/or a mean radius of the nominal contour of the circumferential collar circumferential collar that is preferably less than 1%, more preferably less than 0.5%, and even more preferably less than 0.1%.

This minimization of deviation in the radius allows a special roundness of the piston, so that the diesel engine can be easily designed using pistons that are round and therefore not oval in an unheated state. In contrast to conventional diesel engines, in which the piston must have an ovality in the unheated state to counteract thermal expansion effects. A diesel engine according to the present invention can use round pistons which are much easier to manufacture.

In order to further improve the thermal expansion behavior of the piston, the piston is shaped in such a way that a radially arranged, essentially flat first cross-sectional area extending through the axis of movement and a radially arranged second cross-sectional area extending through the axis of movement have a cross sectional area that preferably varies less than 10%, more preferably less than 7%, even more preferably less than 5%, and in particular less than 2%. The reference to variation here is either with respect to the smallest cross-sectional area or an average cross-sectional area determined from any number of cross-sectional areas.

This means that the dimensions of the corresponding cross-sectional areas of the piston are selected in such a way that the thermal expansion behavior is identical or very similar in different planes, so that the piston can be used over wide temperature ranges in the diesel engine.

A corresponding “cross-sectional area” refers to the cross section which results from an imaginary cutting of the piston on a plane passing through the axis of movement. This cross-sectional area is specified as an area dimension, whereby an important concept of the invention is that the cross-sectional area of any cut taken through the axis of movement is equal to or nearly equal to another cross-sectional area of another cut taken along another plane rotated at an angle of rotation around the axis of movement.

In order to be able to control the thermal expansions of the piston even more precisely, the piston is shaped in such a way that a cross-sectional area of a first cut taken on a plane passing through the axis of movement and a second cross-sectional area of a second cut taken along a second plane also passing through the axis of movement preferably varies less than 7%, even more preferably less than 5% and most preferably less than 2%.

In this context, it should be noted that a first cross-sectional area and a second cross-sectional area each denote any cross-sectional area, for example, in one case two cross-sectional surfaces in different reference planes, for example perpendicular to each other, that are of the same or similar design, so that, for example, a thermal expansion behavior of the piston is controlled in the two main directions. Likewise, the respective cross-sectional areas can run at any angle to each other, so that in particular a comparison of any cross-sectional areas around a circumference of the piston meets the previously mentioned criteria.

In one embodiment, a piston skirt extending from the upper side to the underside and/or beyond the underside is arranged on the circumferential surface, the piston skirt having a radial thickness of preferably less than 10% of the piston diameter, more preferably less than 5% and most preferably less than 2% of a diameter of the piston.

Such a “piston skirt”, which denotes a tube-like extension of the piston in the direction of the underside, i.e. in the direction of the crankshaft, is particularly in this case a thin-walled design, so that thermal expansion is greatly reduced.

In order to achieve a balance with regard to the respective cross-sectional areas compared to, for example, the necessary surface areas, thickenings are added to some parts of the piston (additional material) and pockets are provided on other parts. An equalizing volume and/or several equalizing volumes are arranged on the upper side and/or on the lower side of the piston. The compensating volume and/or the equalizing volumes are used to create a compensation for volume sections of the piston that are recessed at the respective cross-sectional surface.

Consequently, a thickening or thickenings can be arranged in such a way that material of the piston is added at a point where this is not technically absolutely necessary, so that the cross-sectional criteria of the piston can be met.

In one embodiment, on the other hand, or as a supplement, a pocket or several pockets can be recessed on the upper side and/or on the lower side, whereby by means of the pocket volume or pocket volumes, compensation is provided for the volumes at the respective cross-section.

This means that, also in combination with the thickenings, the pockets can be used to compensate for corresponding area sizes.

A “thickening” describes an increase in volume, i.e. an additional material applied, whereas a “pocket” describes a material that is not present or has been removed. For example, when casting a flask with respect to the piston, an additional volume can be provided in the mold, whereby a corresponding pocket can be provided in the resulting cast piston. If the piston is manufactured using a machining process, for example, the corresponding thickenings or pockets can be provided directly in a CNC milling program.

In order to be able to influence the thermal expansion behavior of the piston evenly, several thickenings and/or several pockets are arranged symmetrically to the axis of movement.

In one embodiment, the head region of the connecting rod has a first connection with a thickened portion for connecting a piston, which can rotate about the pivot axis, to a connecting rod holder of the piston which has an undercut corresponding to the thickened portion. The foot area of the same connecting rod has a second connection for receiving a crankpin of the crankshaft and the head region is connected to the foot region via the middle region, wherein the connecting rod has a lubricant channel connecting the second connection to the first connection in a fluid-carrying manner so that the second connection in the area of the crankshaft receives lubricant that is guided through the lubricant channel to the first connection and the lubricant is present for lubricating and/or cooling the first connection.

Such an arrangement, with only a few modifications to known connecting rods, namely the provision of a lubricant channel along the connecting rod, ensures that the first connection between the connecting rod and piston is safely lubricated and/or cooled.

In order to make the connecting rod particularly simple, the lubricant channel runs in the form of a lubricant feed channel, whereby the lubricant channel runs along the central plane of the connecting rod. Such a lubricant channel can, for example, be a bore running along the central plane of the connecting rod, whereby ideally the grains of the metal comprising the connecting rod do not experience significant tensile or compressive stresses. The inclusion of the lubricant channel therefore results in only a negligible weakening of the connecting rod as a whole.

In one embodiment, the lubricant flows from a crankshaft eye associated with the second connection to the head region of the connecting rod, in particular from an inner surface of the crankshaft eye to the head region.

This embodiment of the invention makes it possible, for example, to use an oil passage that is already inside a hollow crankshaft and, in particular, pressurized oil used for the lubrication of bearing points of the crankshaft in an engine housing. Oil fed from such a source can be introduced into the crankshaft eye or into a bearing shell that has a corresponding oil feed hole or borehole so that engine oil escaping with excess pressure at a crankshaft crankpin journal is introduced into the lubricant channel in the connecting rod and used to reliably lubricate and cool the head region of the connecting rod and the first connection between the connecting rod and piston.

In order to be able to manufacture the connecting rod particularly reliably and easily, the lubricant guide is inserted into the connecting rod by means of spark erosion (electro discharge machining) and/or deep drilling.

This type of “spark erosion”, which is also known as “electro discharge machining” can be used for high-precision material processing. The electrically conductive workpiece to be machined is held in a dielectric liquid. An electrically conductive tool is placed in the vicinity of the material and a gap is created between the tool and the workpiece. A voltage difference is used to generate sparks by means of a local discharge between the tool and the workpiece and primarily to remove material from the workpiece by this spark erosion.

In particular, the so-called sinking or drill erosion using a rod-shaped tool produces a channel-like, eroded hole.

In contrast, “deep drilling” can be used as a special type of drilling, whereby deep drilling is characterized by the fact that a drilling depth is increased by many times the drill diameter.

In one embodiment, the lubricant feed through he connecting rod has a lubricant reservoir on the head region, within which the lubricant is introduced in particular into an outer surface of the head region and the pivoting connecting between the head region and the connecting rod holder of the piston.

This feature allows a corresponding retention of lubricant,
i.e. an additional quantity of lubricant available in the area of the head region that can also be used, for example, as a hydraulic cushion to prevent direct workpiece contact between an inner surface of the connecting rod holder and the outer surface of the head region of the connecting rod.

A “lubricant reservoir” can be provided, for example, as a recess in a surface of the connecting rod head.

Likewise, a valve device can be added to this lubricant reservoir or other area of the connecting rod head. This valve device is used to control a lubricant that is introduced into the lubricant channel at the second connection in the area of the crankshaft crankpin and guided through the lubricant channel to the first connection. Lubricant flows through the first connection by means of a swivel movement between the piston and the connecting rod head around the swivel axis.

Consequently, the valve device can be used to adjust the amount of lubricant depending on the angle at which the connecting rod head is swiveled around the swivel axis with respect to the piston. This fact means that the lubricant flow can be regulated so that, for example, lubricant can only flow out of the first connection when the piston and connecting rod is unloaded or only slightly loaded.

The embodiments of this valve device on the connecting rod can assume various forms. In one form the valve device can be incorporated into the connecting rod while in another form the valve device can be incorporated into the piston. In still other embodiments, the valve device could be incorporated into both the piston and the connecting rod. The valve device can incorporate a recess in the outer surface of the connecting rod head or a recess in the surface of the piston that cooperates with the connecting rod head.

In the following, the invention is described by means of examples.

### BRIEF DESCRIPTION OF THE SEVERAL VIEWS OF THE DRAWINGS

FIG. 1 is a perspective view including hidden lines, showing a crank mechanism including a piston and a connecting rod.

FIG. 2a is a side elevation view of the piston from the assembly of FIG. 1.

FIG. 2b is a bottom view showing the piston from the assembly of FIG. 1.

FIG. 2c is a side elevation sectional view showing the piston from the assembly of FIG. 1.

FIG. 2d is a bottom view showing the piston from the assembly of FIG. 1, with section plane callouts.

FIG. 3a is a side elevation view, showing the connecting rod from the assembly of FIG. 1.

FIG. 3b is a perspective view, showing the connecting rod from the assembly of FIG. 1.

FIG. 4 is a side elevation view with partially shown sections, showing an embodiment of a crank drive made according to the present invention.

FIG. 5 is a perspective view with a partial cutaway, showing an internal combustion engine using crank assemblies as provided in the present invention.

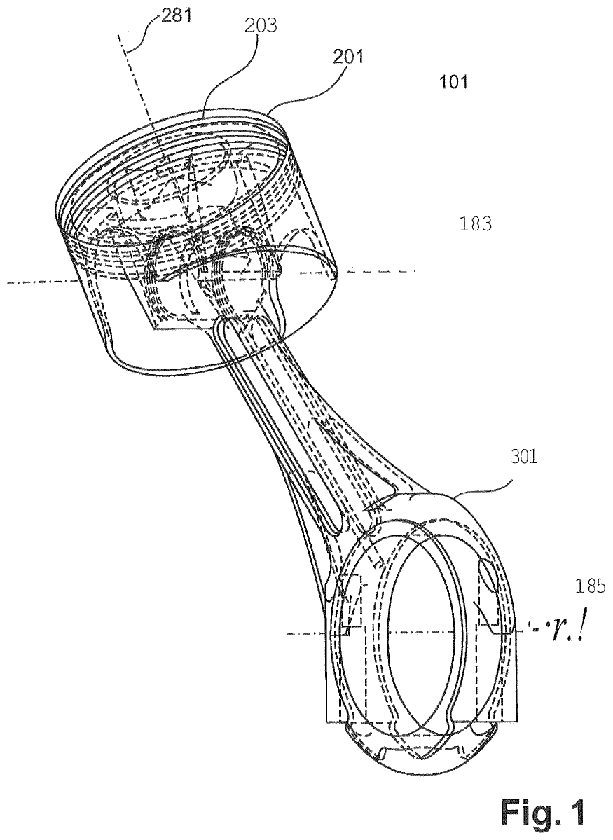

### DETAILED DESCRIPTION OF THE INVENTION

A crank unit 101 has a piston 201 and a connecting rod 301. The crank unit 101 is part of a diesel engine (not shown), whereby the corresponding diesel engine, for example, can have four, six or even eight of these crank units, whereby the respective pistons 201 are accommodated movably along a movement axis 281 within corresponding cylinders. The connecting rod 301 can be moved about a crank axis 185 on respective crankpins of a crankshaft corresponding to the cylinder number. The diesel engine is designed, for example, as an in-line four-cylinder, in-line six-cylinder or V-eight engine. In each case, it is a diesel engine with a high-pressure injection system for diesel fuel and a turbo and/or supercharging, resulting in high combustion temperatures in the respective cylinders. Of course, other designs can also be realized using the crank unit 101. The piston 201 in this example is made of an aluminum alloy.

The respective connecting rod 301 is forged from steel. The connecting rod is pivotally connected to piston 201 about a swivel axis 183, so that when the crankshaft is fully rotated (not shown) the crank axis 185 is guides through a circular motion, and the piston 201 is moved up and down in the cylinder by means of the connecting rod 301. A complete rotation of the crankshaft is thereby performed without mechanical obstacles. On an upper side 203 of the piston 201 the gas pressure generated by the combustion of injected diesel, for example, drives the piston 201 so that the engine is operated according to the diesel principle. The ignition of the injected diesel fuel is achieved through the compression of intake air in the cylinder. The compression temperature of the intake air reaches over 700° C. and the resulting combustion temperature is over 1,200° C. The thermal influences on piston 201 are correspondingly high.

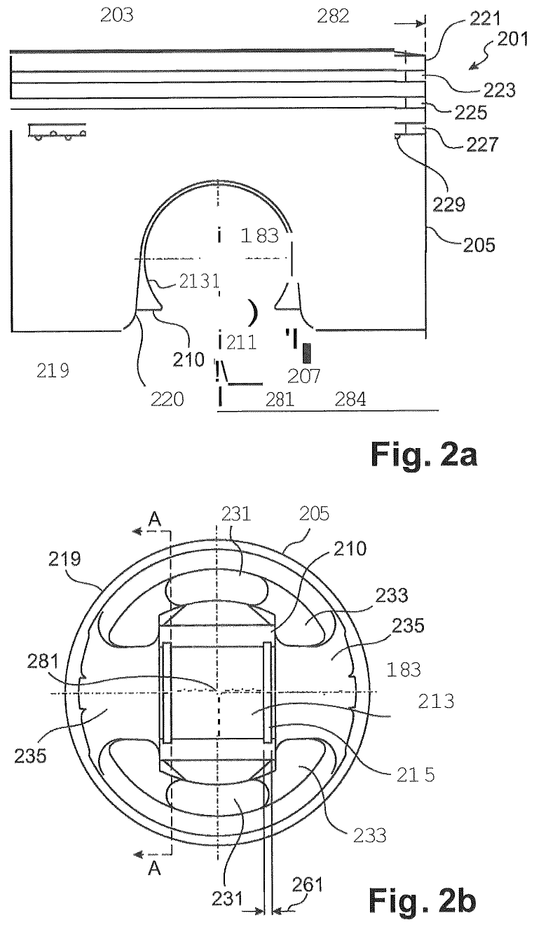

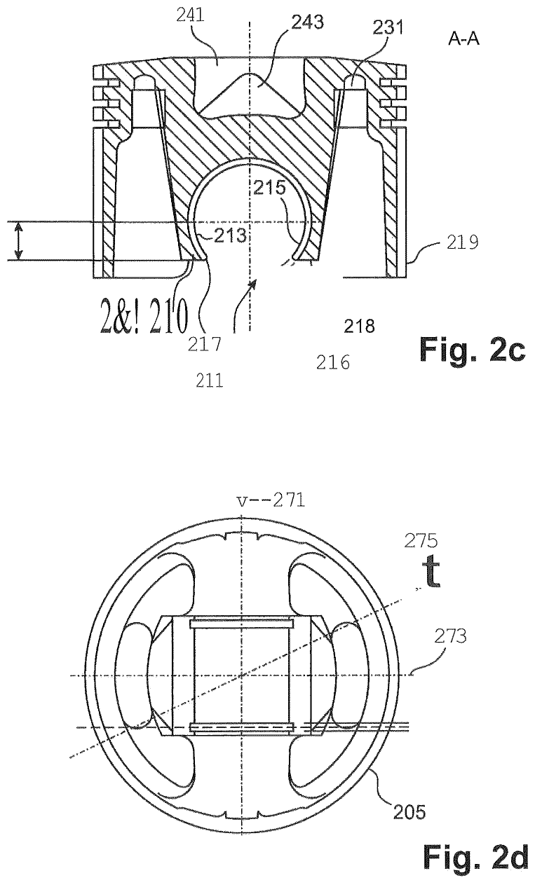

In addition to the upper side (crown) 203 directed towards the combustion chamber in the cylinder, the piston 201 has a circumferential surface 205 and a lower surface 207 (see FIG. 2a). A combustion cavity 241 with a cone-shaped dome 243 (see FIG. 2c) is arranged concentrically to the axis of movement 281 within the upper side. The cone-shaped dome 243 expands the surface area within the combustion cavity 241.

A predominant component of the circumferential surface 205 forms a piston skirt 219 (see FIG. 2c), which descends in the direction of the underside 207. The piston skirt is cylindrical and has thin walls. Starting from the upper side 203, the piston 201 has a narrow circumferential collar 221, which forms a distance from the upper side 203 to a first annular ring groove 223. A piston ring for sealing against the cylinder is arranged within this first annular groove 223. Further in the direction of the underside 207, a second annular ring groove 225 and third annular ring groove 227 are arranged, whereby in the annular groove 225 a piston ring is inserted as a sealing ring, in the annular groove 227 a piston ring in the function of an oil scraper ring (piston rings not shown in each case). Additional bores 229 are arranged on the annular groove 227, which promote the drainage of engine oil.

The circumferential collar 221 is known in the prior art in diesel engines as a so-called “firewall” and in these engines is designed in the prior art with a significantly smaller diameter than the circumferential surface 20 of a piston. However, the circumferential collar 221 in the inventive embodiment of FIG. 2a has a radius 282, this radius 282 being identical to a radius 284 of the circumferential surface 205 within technical tolerances. The piston 201 can thus be machined with respect to its cylindrical shape in a single clamping operation and in a single turning operation on a lathe to a uniform diameter.

The circumferential collar 221 can be designed in this form because the present invention provides additional cooling in order to limit thermal expansion. Collar 221 must be made as a reduced diameter in the prior art to account for increased piston crown heating that causes this area to expand significantly. The heat dissipation in the inventive piston eliminates the need for this.

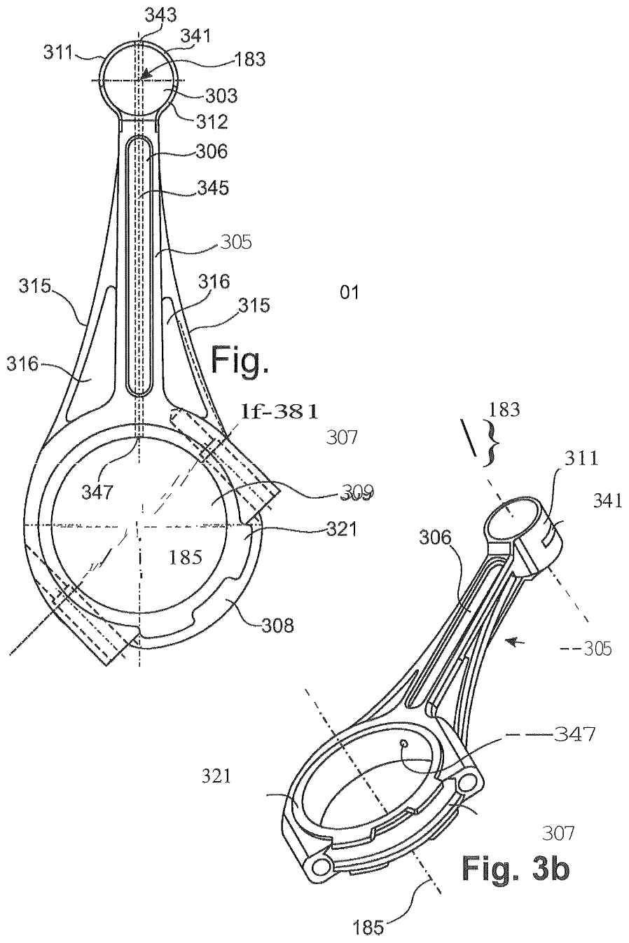

On the underside 207, the piston 201 has a connecting rod holder 210 for engaging the connecting rod 301. The holder 210 is included essentially through an undercut 211 (see FIG. 2c) formed, which is concentric around the swivel axis 183 and is characterized by a respective edge 217 at the limit of the material. In order to keep the undercut 211 accessible along the pivot axis 183 and to enable the undercut 211 to be finished with the inner surface 213 of the connecting rod holder, the piston skirt 219 has a cut-out 220 on both sides along the pivot axis 183. This cut-out 220 allows the connecting rod head 303 (see FIG. 3a) to slide laterally into the connecting rod holder and pivotally engage inner surface 213 (see FIG. 2a). In addition, the presence of cut-outs 220 allows the insertion of a tool for fine machining of the inner surface 213.

As can be seen from the underside of the piston 201 (see also FIG. 2b), the piston 201 is not radially symmetric. In addition to the directly technical volumes of the piston 201, namely the volume for forming the connecting rod holder 210 with the undercut 211, the volume for the piston skirt 219 as well as corresponding volumes for other features vary. Piston 201 has areas of thickening 231,235. The piston also includes numerous pockets 233. The thickenings and pockets are arranged symmetrically to the swivel axis 183. The corresponding volumes of the thickenings 231, the pockets 233 and the thickenings 235 are selected in such a way that both the pockets 233 and the thickenings 235 can be the intersecting surfaces through the axis of movement 281, i.e. for example, such cut surfaces formed along a cutting plane 271, a cutting plane 273 or a cutting plane 275 (see also FIG. 2d), each with the same cross-sectional area within a tolerance of, for example, 2% in relation to the cutting plane 271 to, for example, the smallest of the respective comparative intersecting surfaces. This geometric design ensures that the thermal expansion behavior of the piston 201 is almost identical or even identical in different polar positions around the axis of movement 281. For this purpose, material is added to the thickenings 231 and material is subtracted from the pockets 233 and material is applied to the thickenings 235. In this way, for example, technically required volumes, such as for the pick-up 210, applied in the respective cutting planes are accordingly balanced. Likewise, for example, a respective thickening 235 is provided to at least partially offset the loss of cross-sectional area over the area at the cut-out 220 and missing material in the piston skirt 219. Correspondingly, other components are also compensated for by subtracting or adding corresponding volumes of the material of the piston 201 to keep the piston balanced.

Within the inner surface 213 of the undercut 211, annular retaining ring grooves 215 are provided on both sides along the pivot axis 183 (see FIG. 2b) symmetrically to the axis of movement 281, wherein these annular grooves are formed as partial annular grooves 215 due to the shape of the undercut 211. The respective annular retaining ring groove 215 has a cross-section extending from a diameter 216 of the inner surface 213 up to a diameter 218 of the inner surface 213 (see FIG. 2c).

The connecting rod 301 (see FIG. 3a) has a connecting rod head 303, a middle region 305 and a crankshaft connection 307. The connecting rod head is designed as a bulge with a cylindrical outer surface 311. The outer surface 311 is a machined to be a close sliding and pivoting fit within inner surface 213 of the piston. Furthermore, chamfers 312 are arranged at end regions of the head 303 in the direction of the pivot axis 183. The connecting rod head 303 can thus be inserted laterally into the piston along the pivot axis 183 so that a swivel joint is created between the connecting rod and the piston about the pivot axis 183.

The middle region 305 connects the connecting rod head 303 with the crankshaft connection 307 and has a central neutral plane between the connecting rod head 303 and the crankshaft connection 307. Middle region 305 also has a recess 306 on both sides, so that overall, a rigid cross-section of the middle region 305 is formed as a double T-beam. In addition, webs 315 with recesses 316 formed opposite the middle region 305 are arranged in such a way that the middle region and the crankshaft connection 307 are rigid and yet as light as possible.

Approximately half of the crankshaft connection 307 consists of a part of the connecting rod 301. The other half consists of connecting rod cap 308, with the two components being arranged concentrically around the crankshaft axis 185. In order to produce a low-friction, wear-resistant and emergency-running connection to the crankshaft, a bearing shell 321 is provided on the inner surfaces of the crankshaft eye 309. The bearing shell is provided with features that rotationally fix its position in relation to the connecting rod 301 and rod cap 308.

In addition, the connecting rod 301 has a smaller diameter valve groove 341 on the outer surface area 311 of the connecting rod head 303 (see FIG. 3b). Valve groove 341 is connected to an outlet opening 343 (see FIG. 3a). The outlet opening 343 is part of an oil channel 345, which is located between the outlet opening 343 and an inlet opening 347 arranged inside the crankshaft eye 309. The oil channel 345 is located along the neutral plane of the middle region 305 (the plane where the metal grains are neither in compression nor in tension in normal operation), so that middle region 305 is weakened as little as possible by oil channel 345, against bending.

To fit the connecting rod 301 with the piston 201, the connecting rod head 303 is pushed laterally into the piston's undercut 211 (see FIG. 2a) along the pivot axis 183. Within the annular retaining ring groove 215, an elastic retaining ring with a round wire cross-section is inserted in such a way that part of the retaining ring (not shown) is inserted into the cross-section of the undercut 211 formed by the inner surface 213. This retaining ring is then pushed back into the annular groove 215 by means of the chamfer 312 on the connecting rod head 303, whereby the cross-section of the retaining ring is selected in this way, that it can be positioned completely between the diameter 216 and the diameter 218.

The chamfer 312 thus facilitates the insertion of the connecting rod head 303 into the piston 201. The use of the retaining rings in the retaining ring grooves 215 secures the connecting rod head 303 against unintentional removal from the piston along the pivot axis 183.

The function of the crank unit 101 with regard to the lubrication of the connection between connecting rod head and piston 201 in undercut 211 is explained as follows:

Inside the crankshaft, which is not shown, there is an oil channel running for lubricating the corresponding bearing points of the crankshaft. Crankshaft oil outlet holes are provided at the bearing points. The crankshaft also has corresponding outlet holes for pressurized engine oil on the crankpin journals, which accommodate the respective connecting rod 301 around the crank axis 185. The engine oil is then fed into a circumferential annular groove on the crankshaft and flows through the inlet opening 347 (see FIG. 3a) into the oil channel 345 to the outlet opening 343. With the outlet opening 343 and the valve groove 341, an oil reservoir is created in which pressurized engine oil is stored for the lubrication of the pivoting interface between cylindrical surface 311 (on the connecting rod) and cylindrical inner surface 213 (on the piston).

Furthermore, the valve groove 341 is used to control the oil flow depending on a position of the crankshaft and a resulting position of the connecting rod 301 with respect to the piston 201. When the piston 201 has reached top dead center or bottom dead center, the connecting rod 301 is essentially vertical within the cylinder bore along the axis of movement 281. In that state, the valve groove 341 is completely sealed against the inner surface 213 of the undercut 211 so that no oil can escape through the valve groove 341. At this moment, for example when ignition of the fuel in the cylinder takes place, reliable lubrication and ideal lubrication are ensured and heat transfer between piston 201 and connecting rod 301 is ensured. Likewise, the oil cushion in the oil reservoir also prevents direct material contact.

On the power stroke the piston 201 is heated by the combustion gases and pushed downward. The crankshaft initially pivots from TDC by approximately 90° and the connecting rod 301 pivots with respect to the piston. The valve groove 341 is dimensioned in such a way that a part of the valve groove 341 is now released at an edge 217 of the undercut 211 (see FIG. 2c). At this moment, oil fed through the oil channel 345 under engine pressure is ejected from the open portion of valve groove 341. This oil has been heated as well and its discharge transfers heat away from the connecting rod/piston connection. In this state, the connection between the connecting rod head 303 and the undercut 211 is relatively lightly loaded, so that an escape of the engine oil can be used to advantage here, even if this means that less oil is available for lubrication.

If the crankshaft then approaches bottom dead center (180° from TDC), the undercut 211 closes the valve groove 341; at this moment, inertial forces of the crankshaft can therefore be applied. Further crankshaft rotation commences the exhaust stroke, and this is commenced with full oil pressure contained within the closed valve groove 341. At this point, there is also a further transfer of heat into the engine oil; at a crankshaft position of 270°, the oil pressure is then used to transfer heat out of the engine oil again as the valve groove 341 of the valve is opened by a portion of the valve groove 341 pivoting past edge 217. Up to a crankshaft position of 360° (full angle, corresponds to 0° or TDC), the valve groove 341 is then closed again by means of the edge 217, so that full oil pressure is again present in the connection at top dead center and the availability of renewed heat transfer to the oil dissipation is reached. This cycle is of course repeated with every revolution of the crankshaft, so that the result is sufficient lubrication of the movement around the pivot axis 183 as well as optimized heat dissipation from the connecting rod 301 and the piston 201.

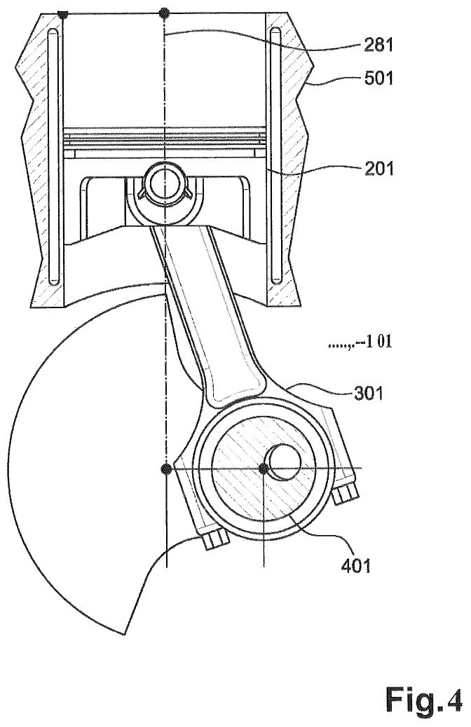

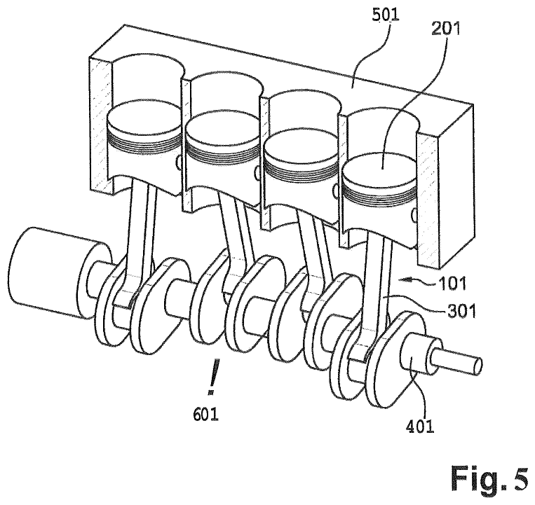

FIG. 4 shows a side view, partially sectioned, of an embodiment example of a crank mechanism according to the invention, wherein the crank mechanism comprises a piston 201 according to one of the embodiment examples described above and a piston 201 according to one of the embodiment examples described above a corresponding connecting rod 301 with an internally located lubricant guide—i.e. a crank unit 101—and a crankshaft 401. The connecting rod 301 is coupled to the crankshaft 401 in the usual manner. The piston 201 is arranged in a cylinder arrangement 501 along a movement movable along the axis 281.

FIG. 5 shows a perspective and partially sectioned view—in a detail—of an embodiment example of a reciprocating piston combustion engine 601 with a cylinder arrangement 501 with four cylinders to form a cylinder bank of an in-line four-cylinder engine and with pistons 201 and connecting rods 301 according to one of the above embodiments. In each case, a piston 201 and a connecting rod 301 form a crank unit 101. The connecting rod 301 is coupled to a crankshaft 401.

In the design examples shown in FIGS. 4 and 5, the “inner workings” of the piston 201 and the connecting rod 301 are not shown for the sake of clarity [61]. In this context, it should be noted that in all embodiments, the geometric design of the piston 201 also optimizes heat dissipation, as explained above. The central connection of the connecting rod 301 in the receptacle 210 of the piston 201 enables good heat conduction, so that the “fire bar” known from the prior art can also be dispensed with. Together with the simple geometry and uniform roundness of the piston 201, this makes it possible to produce a diesel engine that is easy to manufacture and also very efficient.

In this context, it should be noted that in all embodiments, the geometric design of the piston 201 also optimizes heat dissipation, as explained above. The central connection of the connecting rod 301 in the receptacle 210 of the piston 201 enables good heat conduction, so that the “fire bar” known from the prior art can also be dispensed with. Together with the simple geometry and uniform roundness of the piston 201, this makes it possible to produce a diesel engine that is easy to manufacture and also very efficient.

As a result, the diesel engine can be operated with high combustion temperatures and thus reduced emissions and efficient combustion, as the geometry of the piston 201, the compact design and the centralized combustion cavity allows the engine to be operated at high combustion temperatures. The extra heat is dissipated into the connecting rod 301 and by means of the controlled oil flow throughout the rest of the engine. The circulating oil provides good thermal management. Overall, the combination of piston 201 and connecting rod 301 according to the invention thus reduced reciprocating masses. It should be noted that although this type of piston 201 and connecting rod 301 was shown in the present example for a diesel engine with high-pressure injection and a turbocharger, the same arrangement is suitable for other types of engines and machines—including gasoline engines and compressors.

### REFERENCE NUMERALS IN THE DRAWINGS

101 Crank unit
183 Swivel axis
185 Crank axis (crank pin axis)
201 Piston
203 Top side (piston crown)
205 Circumferential surface
207 Underside (lower surface)
210 Connecting rod holder
211 Undercut
213 Inner surface
215 Retaining ring groove
216 Diameter
217 Edge
218 Diameter
219 Piston skirt
220 Cut-out
221 Perimeter collar (circumferential collar)
223 Ring groove (top compression ring groove)
225 Ring groove (second compression ring groove)
227 Ring groove (oil control ring groove)
229 Drill hole
231 Thickening
233 Pocket
235 Thickening
241 Combustion cavity
243 Cone-shaped dome
261 Width
271 Cutting plane
273 Cutting plane
275 Cutting plane
281 Axis of movement
282 Radius
284 Radius
301 Connecting rod
303 Connecting rod head
305 Middle range
306 Deepening (recess)
307 Crankshaft connection
308 Connecting rod cap
309 Crankshaft eye
311 Outer surface
312 Chamfer
315 Bar (web)
316 Recess
321 Bearing shell
341 Valve groove
343 Outlet opening
345 Oil channel
347 Entrance opening
401 Crankshaft
501 Cylinder arrangement
601 Reciprocating internal combustion engine

1. A Diesel engine with high-pressure injection and supercharging and/or a compression temperature of more than 700° C. and/or a combustion temperature of more than 1200° C., one cylinder or several cylinders with a respective cylinder bore, a connecting rod (301) assigned to a respective cylinder and a piston (201) arranged in the respective cylinder bore with an upper side (203), an under side (207) and a circumferential surface (205) with a nominal radius (284), wherein the upper side (203) is designed to absorb compressive forces of a gas within the respective cylinder, bore with an undercut (211) acting in a tensile and a compression direction, so that the connecting rod holder pivotally receives a connecting rod head (303) of the respective connecting rod (301) and the circumferential surface (205) is designed for guiding the piston (201) in the respective cylinder bore along an axis of movement (281) and with a ring groove (223) for a piston ring for sealing the piston (201) with respect to the respective cylinder bore and has a circumferential collar (221) extending from the upper side (203) with a height arranged between the upper side (203) and the ring groove (223) for the piston ring, characterized in that a radius (282) of the circumferential collar (221) is more than 98% of the nominal radius (284) of the circumferential surface (205).

2. The Diesel engine according to claim 1, characterized in that the radius (282) of the circumferential collar (221) is preferably more than 99%, more preferably more than 99.5%, and in particular more than 99.8% of the nominal radius (284) of the circumferential surface (205).

3. The Diesel engine according to claim 1, characterized in that the radius (282) of the circumferential collar (221) is equal to the nominal radius of the circumferential surface (205).

4. The Diesel engine according to claim 1, characterized in that the height of the circumferential collar (221) along the axis of movement (281) is preferably less than 5%, more preferably less than 3%, still more preferably less than 2%, and in particular less than 1% of a height of the piston (201).

5. The Diesel engine according to claim 1, characterized in that a radius of the circumferential surface (205), a radius of the circumferential collar (221), a radius of a nominal contour of the circumferential surface (205) and/or a radius of the nominal contour of the circumferential collar (221) deviates from a mean radius of the circumferential surface (205), by less than 1%.

6. The Diesel engine according to claim 1, characterized in that the piston (201) is shaped in such a way that a cross-sectional area of a first cross-sectional plane (271) extending through the axis of movement (281) and arranged radially and substantially planar and a second cross-sectional area of a second cross-sectional plane (273, 275) extending radially through the axis of movement and arranged substantially planar have a size differing from one another by less than 10%.

7. The Diesel engine according to claim 6, characterized in that on the upper side (203) and/or on the under side (207), a thickening (231, 235) and/or a plurality of thickenings (231, 235) are arranged, wherein an equalization is created by means of the thickening (231, 235) and/or by means of the thickenings (231,235) for sections of the piston (201) taken out at the respective cross-sectional planes (271, 273, 275).

8. The Diesel engine according to claim 6, characterized in that a pocket (233) and/or a plurality of pockets (233) are included on the top side (203) and/or on the under side (207), wherein by means of the pocket (233) and/or by means of the pockets (233), a compensation is created for volume sections of the piston (201) arranged on the respective cross-sectional planes (271, 273, 275).

9. The Diesel engine according to claim 1, characterized in that the connecting rod (301) has a connecting rod head (303) with a first connection corresponding to the undercut (211) of the connecting rod holder (210) for connecting the piston (201) so as to be rotatable about the pivot axis (183), a second connection (307) for receiving a crankshaft and a middle region (305), the middle region (305) connecting the connecting rod head (303) to the second connection (307), wherein the connecting rod (301) has a lubricant channel (343, 345, 347) connecting the second connection (307) to the first connection at head region (303) in a fluid-conducting manner, so that a lubricant introduced into the lubricant channel (343, 345, 347) at the second connection (307) in the region of the crankshaft is guided through the lubricant channel (343, 345, 347) to the first connection at head region (303) and the lubricant is used for lubricating and/or cooling the first connection.

10. The Diesel engine according to claim 9, characterized in that the connecting rod holder (210) has a control device for controlling a lubricant flow introduced into the lubricant channel (343, 345, 347) at the second connection (307) in the region of the crankshaft and guided through the lubricant channel (343, 345, 347) to the first connection at head region (303), wherein, in particular, the control device has a control pocket introduced into an inner surface (213) of the undercut (211) or a plurality of control pockets introduced into an inner surface (213) of the undercut (211), so that the lubricant flow is limited or prevented in particular in the region of a top dead center and/or in the region of a bottom dead center of the piston (201) in the cylinder bore and/or a substantially rectilinear arrangement of the connecting rod (301) in relation to an axis of movement (281) of the piston in the cylinder bore.

11. (canceled)
